(19) United States
(12) Patent Application Publication
(10) Pub. No.: US 2021/0365589 A1
(43) Pub. Date: Nov. 25, 2021

(54) SENSITIVE INFORMATION OBFUSCATION DURING SCREEN SHARE

(71) Applicant: Citrix Systems, Inc., Fort Lauderdale, FL (US)

(72) Inventors: Zongpeng Qiao, Nanjing (CN); Jie Zhuang, Nanjing (CN); Xiao Zhang, Nanjing (CN); Dongsheng Xu, Nanjing (CN)

(21) Appl. No.: 16/910,615

(22) Filed: Jun. 24, 2020

Related U.S. Application Data
(63) Continuation of application No. PCT/CN2020/091951, filed on May 23, 2020.

(51) Int. Cl. G06F 21/62; G06F 21/84; G06F 21/54; G06F 40/30; G06F 9/54; H04L 29/06

(52) U.S. Cl. CPC G06F 21/6254; G06F 21/84; G06F 21/54; G06F 40/30; G06F 2221/032; H04L 65/4007; H04L 65/403; H04L 65/1069; G06F 9/542

(57) ABSTRACT

Techniques are disclosed for protection of sensitive information on a computing device based on a security state of the environment in which the computing device is operating. An example methodology implementing the techniques includes determining that an application having screen share capability is running on a computing device and determining a security state of an environment of the computing device. The method also includes, responsive to a determination that the security state is unsecure, obfuscating sensitive information included in a notification displayed within an application window being displayed by the computing device.

### CROSS REFERENCE TO RELATED APPLICATION

This application claims the benefit of PCT Patent Application No. PCT/CN2020/091951 filed on May 23, 2020 in the English Language in the State Intellectual Property Office, the contents of which are hereby incorporated herein by reference in its entirety.

### BACKGROUND

Due, at least in part, to the increasing reliance on cloud-based services and platforms, organizations, such as companies, enterprises, governments, and agencies, are implementing digital workspace solutions. These digital workplace solutions provide an integrated technology framework designed to deliver and manage applications, data, and desktop delivery. For example, through the digital workspace, employees are able to access the systems and tools they need from any device, such as desktop, laptop, tablet, and smartphone, regardless of location.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one example embodiment provided to illustrate the broader concepts, systems, and techniques described herein, a method may include, responsive to a determination, by a computing device, that a screen sharing application is running in an unsecure environment, identifying sensitive information included in a notification displayed within an application window being displayed by the computing device, and obfuscating the identified sensitive information. The method may also include, responsive to a determination, by the computing device, that the screen sharing application is running in an uncertain environment, providing a warning regarding a potential leak of sensitive information included in the notification displayed within the application window being displayed by the computing device.

According to another illustrative embodiment provided to illustrate the broader concepts described herein, a system includes a memory and one or more processors in communication with the memory. The processor may be configured to, responsive to a determination that a screen sharing application is running in an unsecure environment, identify sensitive information included in a notification displayed within an application window being displayed by the system, and obfuscate the identified sensitive information. The processor may be also configured to, responsive to a determination that the screen sharing application is running in an uncertain environment, provide a warning regarding a potential leak of sensitive information included in the notification displayed within the application window being displayed by the system.

According to another illustrative embodiment provided to illustrate the broader concepts described herein, a method may include determining that an application having screen share capability is running on a computing device, determining a security state of an environment of the computing device, and, responsive to a determination that the security state is unsecure, obfuscating sensitive information included in a notification displayed within an application window being displayed by the computing device.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a flow diagram illustrating an example sensitive information obfuscation process, in accordance with an embodiment of the present disclosure.

FIG. 6 is a diagram environment security states and corresponding security actions, in accordance with an embodiment of the present disclosure.

FIG. 7 is a diagram of an example application window that displays content including sensitive information, in accordance with an embodiment of the present disclosure.

FIG. 8 is a diagram of an application window that displays sensitive information in obfuscated form, in accordance with an embodiment of the present disclosure.

FIG. 9 is a diagram showing example notifications and associated security tags, in accordance with an embodiment of the present disclosure.

FIG. 10 is a block diagram illustrating an example implementation of a resource access application for performing sensitive information obfuscation as variously described herein.

FIG. 11 is a block diagram illustrating another example implementation of a resource access application for performing sensitive information obfuscation as variously described herein.

FIG. 12 is a flow diagram of an example process for determining a security state of an environment, in accordance with an embodiment of the present disclosure.

FIG. 13 is a flow diagram of an example process for determining security based on displays of a client device, in accordance with an embodiment of the present disclosure.

FIG. 14 is a flow diagram of an example process for determining security of displays of a client device, in accordance with an embodiment of the present disclosure.

FIG. 15 is a flow diagram of an example process for determining security based on an image of the environment, in accordance with an embodiment of the present disclosure.

### DETAILED DESCRIPTION

As used herein, the term “sensitive information”, or “sensitive content”, or “confidential information”, or “confidential content” includes any information or content that is either legally confidential or identified by an individual/organization as being only intended to be seen/viewed by the user themselves, or intended to be seen/viewed by any one or more other persons authorized by this user. Other terms may also be used to refer to information or content that is either legally confidential/sensitive or identified by an individual/organization as being only for the eyes of the user themselves, or any one or more other persons authorized by this user. Non-limiting examples of sensitive information include any data that could potentially be used to identify a particular individual (e.g., a full name, Social Security number, driver's license number, bank account number, passport number, and email address), financial information regarding an individual/organization, information deemed confidential by the individual/organization (e.g., contracts, sales quotes, customer contact information, phone numbers, personal information about employees, and employee compensation information), and information classified by a governing authority as being confidential.

A digital workspace provides an infrastructure that empowers employees to work from anywhere. For example, an employee can access and display data, including sensitive information, using a computing device from any location. However, when sensitive information is displayed, there is a risk that such displayed sensitive information may be leaked or otherwise compromised. For example, unauthorized persons nearby the display may be able to view the sensitive information being displayed on the display device.

Concepts, devices, systems, and techniques are disclosed for protection of sensitive information on a computing device based on a security state of the environment in which the computing device is operating (i.e., environment of the computing device). In embodiments, sensitive information protection is achieved by obfuscation of the sensitive information on a display of the computing device. The security state of the environment may be determined from one or more multi-dimensional factors including, but not limited to, security of a display (i.e., monitor) or displays of the computing device, number of displays coupled to the computing device, and/or analysis of an image or images of the surrounding environment of the computing device. In some embodiments, if a determination is made that the environment is secure (i.e., security state is secure), then sensitive information protection is not enabled. For example, in such cases, sensitive information may be displayed normally in unobfuscated form. If a determination is made that the environment is not secure (i.e., security state is unsecure), then sensitive information protection may be enabled. For example, in such cases, the sensitive information may be displayed in obfuscated form. If the state of the environment uncertain (i.e., security state cannot be determined), a user may be prompted to indicate the security state of the environment, and sensitive information protection may be enabled or not enabled be based on the security state indicated by the user.

For example, and according to an embodiment, a user may be running application software (or more simply an “application”) on a computing device that displays content, which may contain (include) sensitive information, on a display of the computing device. The computing device may be programmed or otherwise configured to determine whether an application capable of screen sharing (also referred to herein generally as a “screen sharing application”) is running on the computing device. More specifically, in an embodiment, the computing device can determine whether a running screen sharing application is sending data over a network. If the screen sharing application running on the computing device is sending data over the network, the computing device can conclude that the display of the computing device is not secure. For example, the screen sharing application may be intentionally or inadvertently sharing the content being displayed on the display of the computing device, thus exposing the sensitive information to potential data loss or leakage. Since the display of the computing device is not secure, the computing device can conclude that it is operating in an unsecure environment (i.e., that the environment of the computing device is not secure). In this case, the computing device can display the sensitive information in obfuscated form. Sensitive information may be obfuscated, for example, by applying an overlay with sufficient distortion effects (e.g., a black-out box), applying a transformation, adding artifacts, and/or redaction, to prevent viewing of the sensitive information.

In some embodiments, prior to displaying sensitive information, the computing device can determine whether there are multiple displays coupled to the computing device. If it is determined that multiple displays are coupled to the computing device, the computing device can conclude that it may be operating in an unsecure environment and that there is a possibility that the sensitive information may be displayed on a display that is viewable by other users (e.g., users other than the user of the computing device). In this case, the computing device can display the sensitive information in obfuscated form. For example, in an implementation, the computing device can check for the number of displays upon determining that a screen sharing application is running on the computing device. In another implementation, the computing device can check for the number of displays independent of the check for a screen sharing application running on the computing device. In any case, the computing device can display the sensitive information in obfuscated form upon determining that multiple displays are coupled to the computing device.

In some embodiments, prior to displaying sensitive information, the computing device can determine whether a large-format display is coupled to the computing device. For example, use of a large-format display makes it easier for other users (e.g., users other than the user of the computing device) to view the content that is displayed on the large-format display. In an embodiment, the computing device can conclude that a display coupled to the computing device is a large-format display if the display has a screen that is at least 34 inches (i.e., a 34 inch display). If it is determined that a large-format display is coupled to the computing device, the computing device can conclude that it may be operating in an unsecure environment and that there is a possibility that the sensitive information displayed may be displayed on the large-format display and viewable by other users. In this case, the computing device can display the sensitive information in obfuscated form.

In some embodiments, prior to displaying sensitive information, the computing device can determine whether it is operating in a secure environment based on analysis of an image of the environment of the computing device. For example, in an implementation, the computing device may include an image capture device, such as a webcam. The computing device may be configured to capture an image of the surrounding environment upon determining that sensitive information is about to be displayed. The computing device can then compare the captured image with one or more images from a whitelist. These whitelist images may include previously taken images of persons, objects, and/or scenes that represent or indicate a secure environment. In an embodiment, the computing device can conclude that it is operating in a secure environment (i.e., the environment of the computing device is secure) if the captured image matches an image from the whitelist. Otherwise, if the captured image does not match any of the images from the whitelist (e.g., the captured image includes an object or objects that is not present in the whitelist images), the computing device can conclude that the security state of the environment of the computing device is uncertain. In this case, the computing device can display a warning message informing of the potential for data loss or leak of displayed sensitive information. In an implementation, the computing device may also prompt a user to specify the security state of the environment (i.e., indicate whether the environment is secure or unsecure). The computing device can then display sensitive information in normal form (i.e., unobfuscated form) or in obfuscated form based on the security state indicated by the user.

In an implementation, the computing device can capture an image of the environment and compare the captured image with one or more whitelist images to determine the security state of the environment upon determining that a screen sharing application is running on the computing device. In another implementation, the computing device can capture an image of the environment and compare the captured image with whitelist images to determine the security state of the environment independent of the check for screen sharing application running on the computing device. In any case, if the comparison of the image with whitelist images fails to indicate that the computing device is running in a secure environment, the computing device can display a warning message and prompt a user to indicate the security state of the environment prior to the display of sensitive information on a display of the computing device. These and other advantages, variations, and embodiments will be apparent in light of this disclosure.

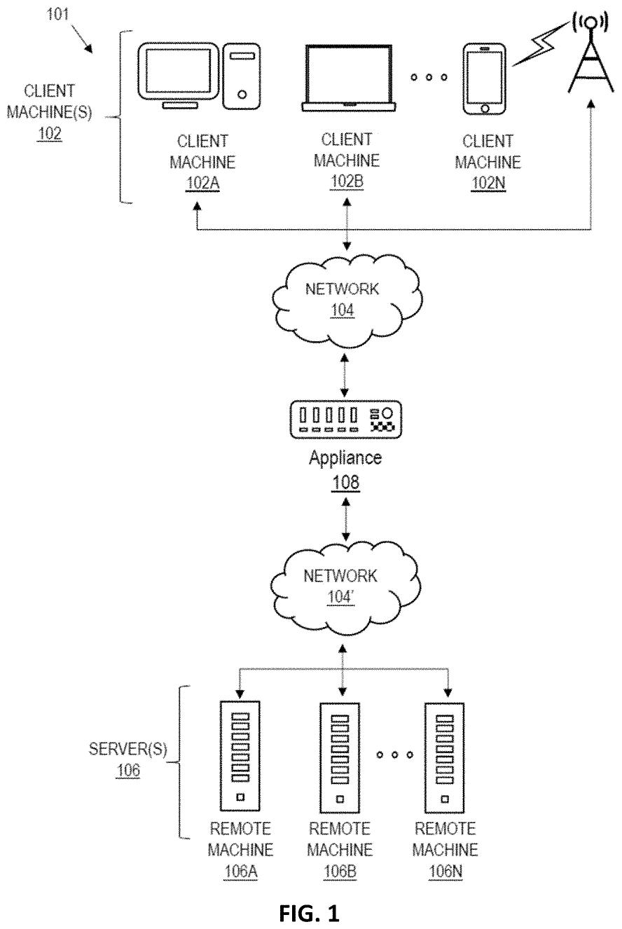

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

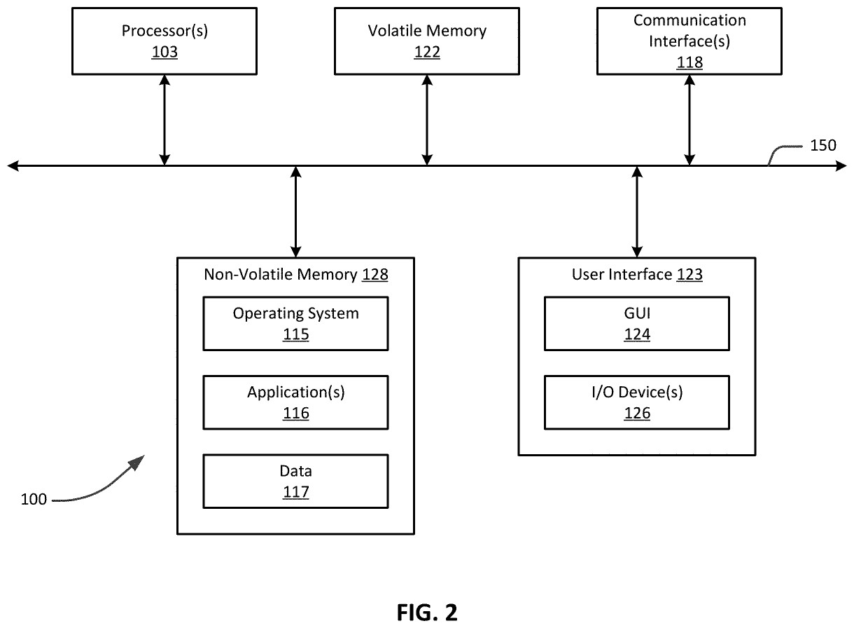

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

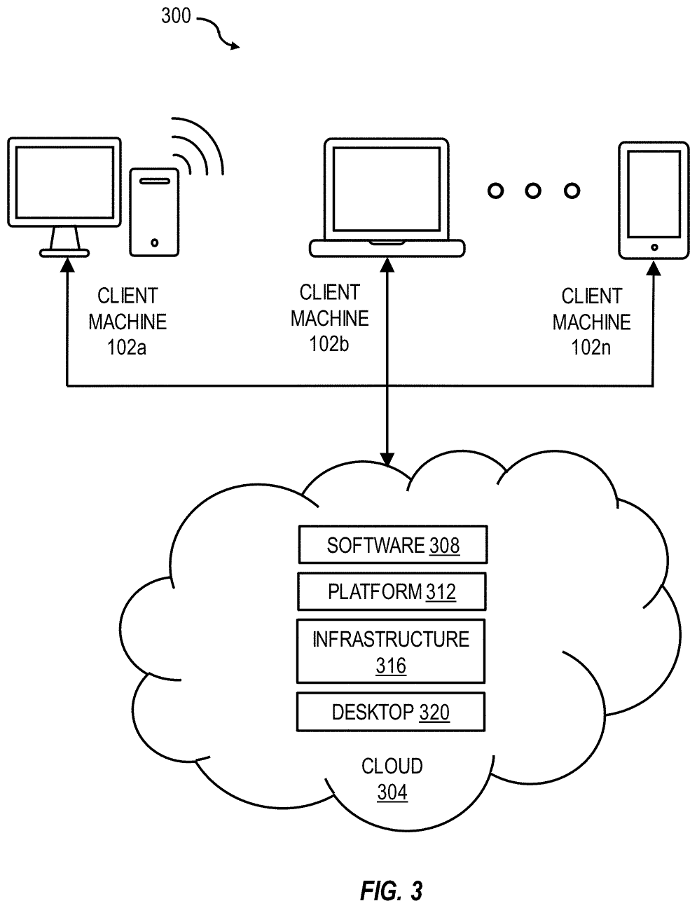

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

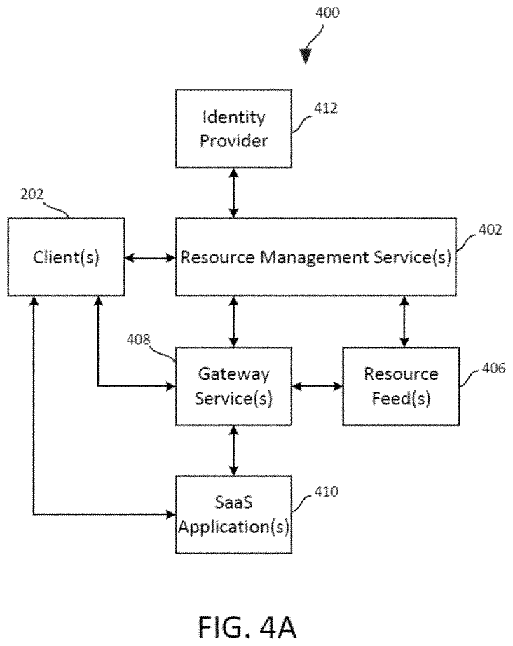

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

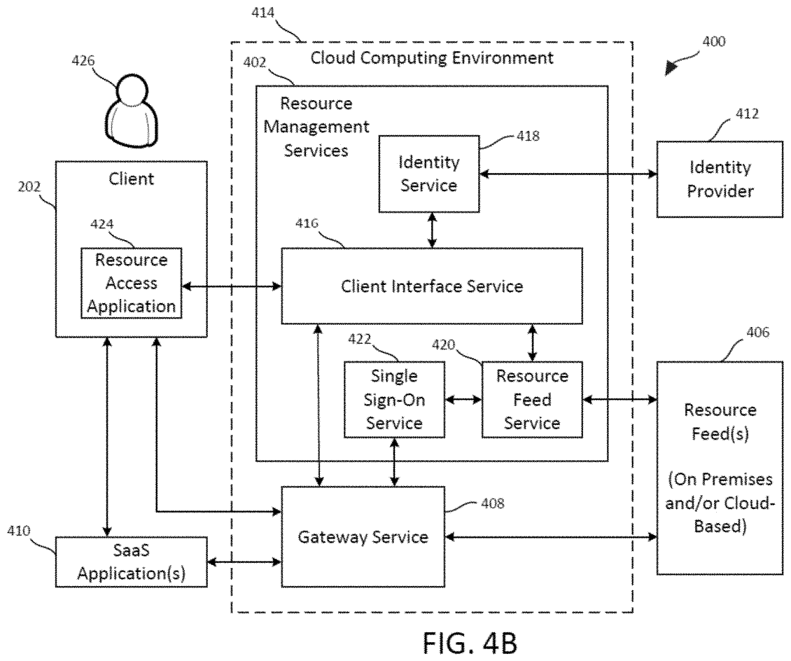

FIG. 5 is a flow diagram illustrating an example sensitive information obfuscation process 500, in accordance with an embodiment of the present disclosure. As can be seen, process 500 includes a number of phases and sub-processes, the sequence of which may vary from one embodiment to another. However, when considered in the aggregate, these phases and sub-processes form part of an improved sensitive information protection mechanism that is capable of protecting sensitive information in the display of the sensitive information. Process 500 is responsive to detected and/or observed user behavior in accordance with certain of the embodiments disclosed herein and, in an embodiment, can be implemented using a computer system such as client 202 of system 400 of FIGS. 4A-4C and described herein. However, the correlation of the various functionalities shown in FIG. 5 to the specific components illustrated in FIGS. 4A-4C is not intended to imply any structural or use limitations. Rather, other embodiments may include, for example, varying degrees of integration wherein certain functionalities may be effectively performed or provided by other systems, components, or modules. For example, in other embodiments, process 500 can be implemented using client device 102 of computing environment 300 of FIG. 3, wherein content may be provided to client device 102 by cloud computing services, such as SaaS 308 as described herein. Thus, implementation of process 500 as described herein should not be understood as being limited to any particular system, environment, and/or architecture, and numerous variations and alternative configurations will be apparent in light of this disclosure.

With reference to process 500 of FIG. 5, user 426 may be using resource access application 424, such as Citrix Workspace app, running on client 202 to access SaaS applications 410. In response to user 426 interactions with resource access application 424, SaaS applications 410 may send or otherwise provide content to resource access application 424 for rendering on a display of client 202. Resource access application 424 can then display the content based on the security state of the environment in which client 202 is operating (i.e., the environment of client 202). To this end, at 502, client 202 may detect that screen sharing is being performed on the device. The screen sharing may be being performed by resource access application 424 or another application, such as a screen sharing application, running on client 202.

At 504, client 202 may determine the security state of the environment of client 202. In some embodiments, the security state may be determined based on multi-dimensional factors such as the security of a display (i.e., monitor) or displays of client 202, number of displays coupled to client 202, and/or analysis of an image or images of the surrounding environment of client 202. In some embodiments, client 202 may conclude that the security state of the environment is not secure if any one or more of the multi-dimensional factors indicate that the environment of client 202 is not secure.

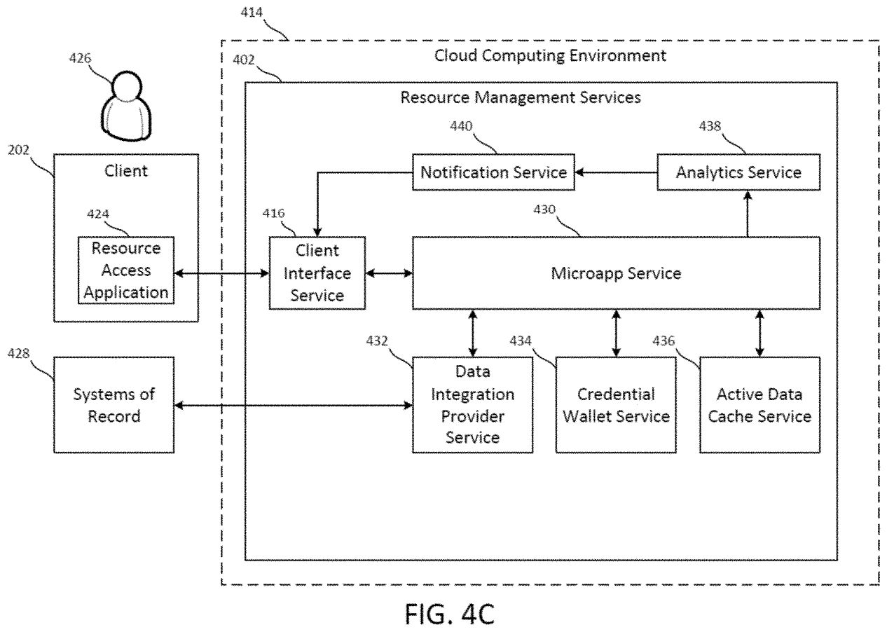

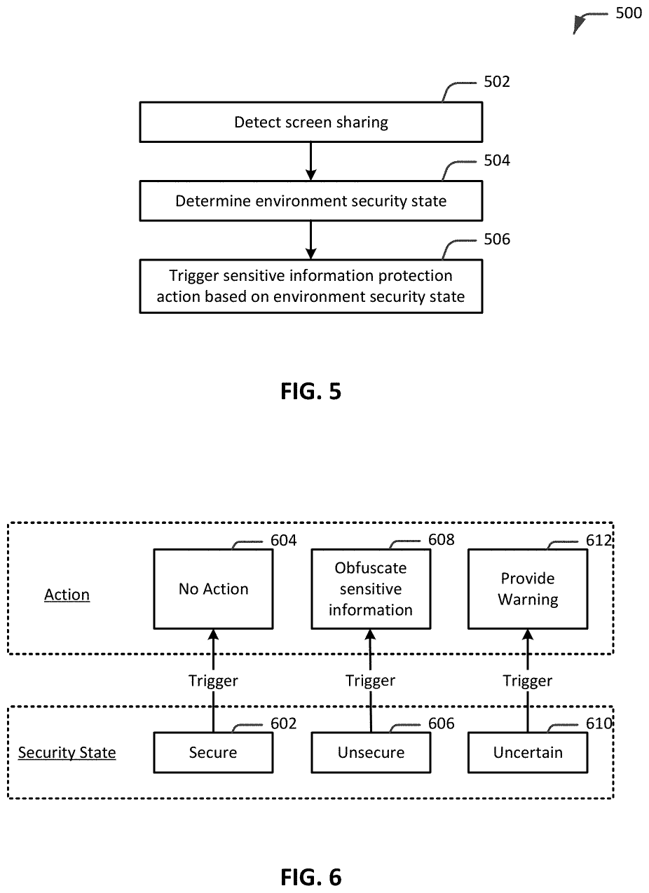

At 506, sensitive information protection action may be triggered on client 202 based on the security state of the environment. For example, as can be seen in FIG. 6, if the security state of the environment is determined to be secure (see reference numeral 602 in FIG. 6), sensitive information protection is not enabled on client 202. In this case, with respect to the display of sensitive information, no action is taken to obfuscate the sensitive information being displayed on a display of client 202 (see reference numeral 604 in FIG. 6). One example of an application window including sensitive information displayed normally in unobfuscated form is further described below at least in conjunction with FIG. 7.

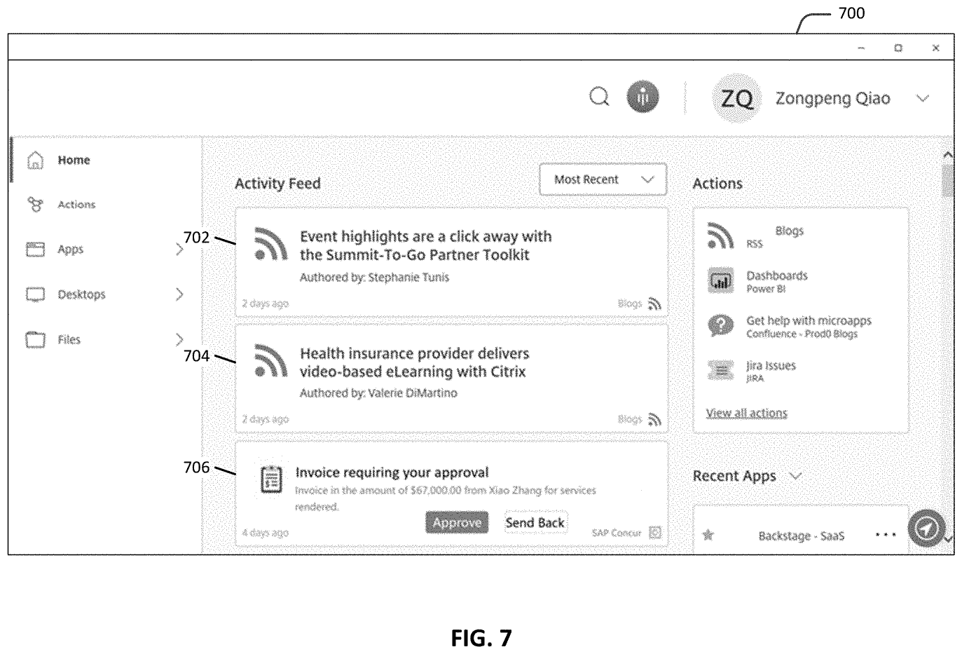

If the security state of the environment is determined to be unsecure (see reference numeral 606 in FIG. 6), sensitive information protection is enabled on client 202. In this case, with respect to the display of sensitive information, the action taken may be to obfuscate the sensitive information being displayed on a display of client 202 (see reference numeral 608 in FIG. 6). One example of an application window including sensitive information displayed in obfuscated form is further described below at least in conjunction with FIG. 8.

If the security state of the environment is uncertain (see reference numeral 610 in FIG. 6), the action triggered on client 202 may be to provide a warning (see reference numeral 612 in FIG. 6). For example, client 202 may display a warning on a display of client 202 informing user 426 of the potential for data loss or leak if sensitive information is displayed. In an embodiment, if the security state is uncertain, user 426 may be also prompted to indicate the security state of the environment.

FIG. 7 is a diagram of an example application window 700 that displays content including sensitive information, in accordance with an embodiment of the present disclosure. As explained above in conjunction with FIG. 6, application window 700 may be displayed on a display of client 202 upon a determination that the security state of the environment is secure. For example, a user (e.g., user 426) may use a client application (e.g., resource access application 424) running on client 202 to access an application (e.g., SaaS application 410). In response, the accessed application may send or otherwise provide to the client application contents of application window 700 for rendering on the display of client 202. Prior to rendering the contents of application window 700, the client application can check and determine that the security state of the environment is secure and render application window 700 on the display of client 202.

As shown in FIG. 7, application window 700 includes notifications 702-706 among other elements. The notifications displayed in application window 700 may be a listing of content that is accessible by the user by clicking or tapping the notifications. To this end, the notifications may be links to the content represented or identified by the notifications. For example, as can be seen, notification 702 may be a link to a blog titled “Event highlights are a click away with the Summit-To-Go Partner Toolkit”. Notification 702 may also include information regarding the author of the blog (“Authored by: Stephanie Tunis”), the time of the last or most recent blog entry (“2 days ago”), and an indication of the type of feed (e.g., symbol for RSS). Similarly, notification 704 may be a link to a blog titled “Health insurance provider delivers video-based eLearning with Citrix”, and may also include information regarding the author of the blog (“Authored by: Valerie DiMartino”), the time of the last or most recent blog entry (“2 days ago”), and an indication of the type of feed (e.g., symbol for RSS). Notification 706 may be a link to a notification of an invoice item titled “Invoice requiring your approval”, and may include a summary or snippet from the invoice item (“Invoice in the amount of $67,000.00 from Xiao Zhang for services rendered”), the time of the notification (“4 days ago”), and control elements to approve (“Approve” button) or reject (“Send Back”) the invoice item.

In the example embodiment of FIG. 7, the content provided with notifications 702 and 704 (e.g., title, information regarding the author, information regarding the last entry, summary or snippet, etc.) do not include sensitive information. In other words, notifications 702 and 704 in application window 700 do not display information that may be considered sensitive. In contrast, the content provided with notification 706 includes sensitive information. For instance, specific details of the invoice, such as the amount of the invoice (e.g., $67,000.00) and other details of the transaction (e.g., information identifying the provider of the service and information describing the provided service) may be considered sensitive. However, since the security state of the environment is determined to be secure, the client application can render application window 700 on the display of client 202 such that the sensitive information included in notification 706 is viewable and not obfuscated or hidden from view as shown in FIG. 7.

FIG. 8 is a diagram of application window 800 that displays sensitive information in obfuscated form, in accordance with an embodiment of the present disclosure. Many of the elements in application window 800 are similar to the elements in application window 700 described above in conjunction with FIG. 7. Unless context dictates otherwise, those elements in application window 800 that are labeled identically to elements in application window 700 will not be described again for purposes of clarity. As explained above in conjunction with FIG. 6, application window 800 may be displayed on a display of client 202 upon a determination that the security state of the environment is not secure.

In the example embodiment of FIG. 8, since the security state of the environment is determined to be not secure, the client application can render application window 800 on the display of client 202 such that the sensitive information included in notification 706 is obfuscated and hidden from view. For example, as shown in FIG. 8, notification 706 may include a display element 802 that obfuscates or hides the sensitive information of notification 706 from view. In an example implementation, a display element (e.g., display element 802) that obfuscates sensitive information may include non-sensitive information, such as non-sensitive information describing or regarding a notification.

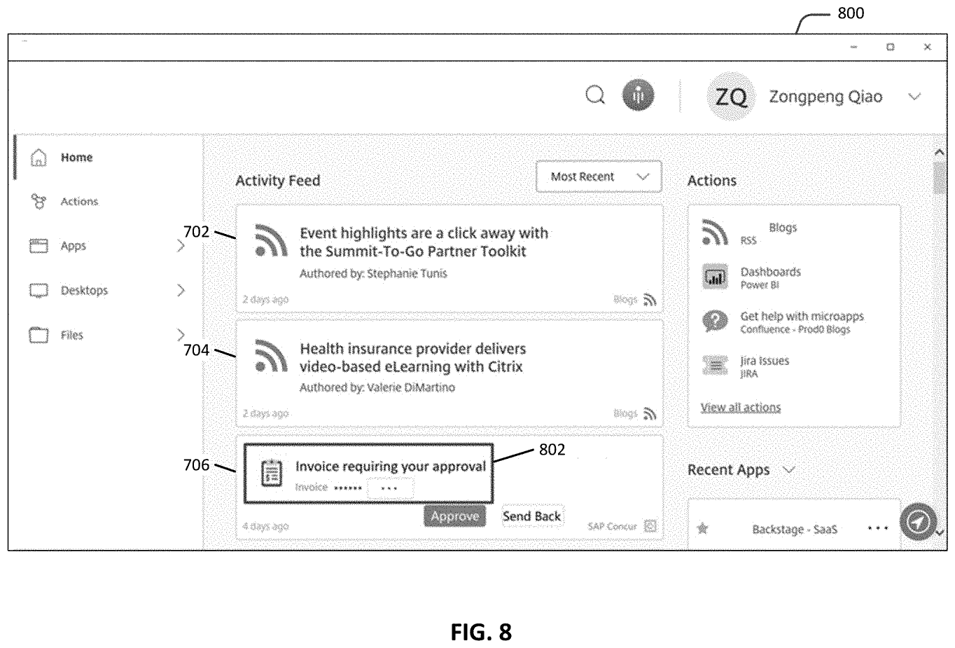

In some embodiments, the client application (e.g., resource access application 424) may maintain security tags for the notifications to indicate whether a notification includes sensitive information. For example, in an implementation, upon receiving the notifications from the content server or provider (e.g., SaaS application 410), the client application may assign to the notifications security tags that indicate whether the notifications include sensitive information. As shown in FIG. 9, the client application can assign a security tag 902 to notification 702, a security tag 904 to notification 704, and a security tag 906 to notification 706. Although only three notifications and corresponding security tags are shown in FIG. 9, it will be understood that the client application may receive and assign security tags to any number of notifications.

Still referring to FIG. 9, the security tag may be implemented as a “True” or “False” flag that indicates whether a notification includes sensitive information (e.g., security tag set to True) or dies not include sensitive information (e.g., security tag set to False). In such implementations, security tag 902 may be set to False to indicate that notification 702 does not include sensitive information, security tag 904 may be set to False to indicate that notification 704 does not include sensitive information, and security tag 906 may be set to True to indicate that notification 706 includes sensitive information. Assigning security tags to notifications in this manner allows the client application to quickly and efficiently identify notifications that include sensitive information.

In some embodiments, the client application may utilize an optical character recognition/data loss prevention (OCR/DLP) technique or service to determine whether a notification (e.g., content to be rendered on a display of client 202) includes sensitive information. The notification may include content that may be in a text-based format (e.g., textual data) or an image-based format (e.g., an image of the content). In the case of an image, the OCR/DLP technique or service may use optical character recognition (OCR) to convert the image of the content to textual data. It will be appreciated that other methods/techniques of text extraction may also be used (e.g., textual data may be embedded in the content and extracted). In any case, OCR/DLP technique or service may scan the content of the notification to identify items of sensitive information contained in the content.

For example, the OCR/DLP technique or service may scan the textual data for certain keywords or phrases, and/or search the textual data using regular expressions, for patterns of characters to identify items of sensitive information contained in the content of the notification. Non-limiting examples of sensitive information include any data that could potentially be used to identify a particular individual (e.g., a full name, Social Security Number, driver's license number, bank account number, passport number, and email address), financial information regarding an individual/organization, and information deemed confidential by the individual/organization (e.g., contracts, sales quotes, customer contact information, phone numbers, personal information about employees, and employee compensation information). Other pattern recognition techniques may be used to identify items of sensitive information.

The OCR/DLP technique or service may determine the location of any identified item of sensitive information within the content. For example, in the case of textual content, an OCR process and/or a text extraction process of the OCR/DLP technique or service may tag recognized words or characters in the content with location data indicating absolute or relative (e.g., with respect to other display elements) display position data, such as coordinates. Then, for identified items of sensitive information, the OCR/DLP technique or service can provide to the client application, for example, a starting and ending character location which contains the item of sensitive information. In the case of an image, for identified items of sensitive information, the OCR/DLP technique or service can provide to the client application, for example, a location of a bounding rectangle (e.g., coordinates of the four corners of the bounding rectangle) that delineates or defines the bounds (e.g., boundary) of the identified item of sensitive information. In any case, the client application can then locate the sensitive information in the content of the notification and obfuscate the display of the sensitive information, as appropriate (e.g., in cases where the security state of the environment is determined to be not secure).

In some embodiments, the client application may determine whether a notification includes sensitive information based on the application or type of application that is providing the notification. For example, the client application may maintain a list of applications or types of applications that are likely to provide notifications that include sensitive information, such as accounting applications, finance applications, product design applications, project management applications, and authentication applications, to name a few examples. Then, if a notification is from or otherwise provided by an application or type of application that is in the list, the client application can identify the notification as including sensitive information.

In some embodiments, the notifications may include an indication as to whether it includes sensitive information. For instance, an application (e.g., content provider or service) that is providing to the client application a notification can provide with the notification an indication as to whether the notification includes sensitive information.

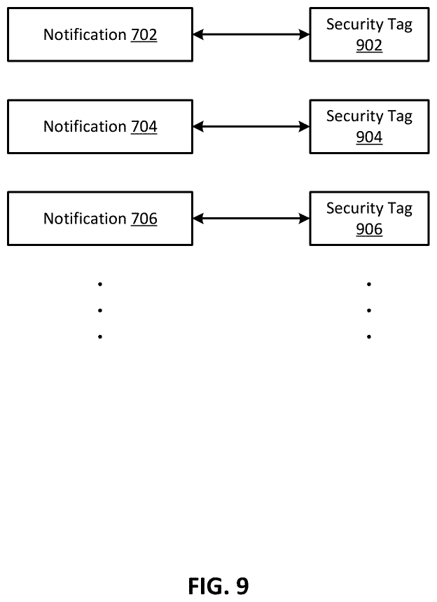

In some embodiments, and referring now to FIG. 10, resource access application 424 may be implemented as a native application on client 202. In such an implementation, as can be seen in FIG. 10, resource access application 424 on client 202 may include an environment monitor plugin 1002 that is configured to maintain the security tags for the notifications of resource access application 424. For example, in an implementation, upon receiving the notifications, environment monitor plugin 1002 can assign to the notifications security tags that indicate whether the corresponding notifications include sensitive information.

Environment monitor plugin 1002 may request services of the underlying operating system (e.g., the operating system of client 202) using a library or API supported by the operating system. For example, environment monitor plugin 1002 may be configured to utilize such library or API of the underlying operating system to determine a security state of the environment of client 202. To this end, environment monitor plugin 1002 can utilize the library or API of the operating system to determine what processes are running on client 202, determine what network communication is being performed, determine the number of displays coupled to client 202 as well as other configuration information, and trigger operation of a recording means of client 202. Environment monitor plugin 1002 may also be configured to perform or not perform the sensitive information protection action on client 202 as variously described herein.

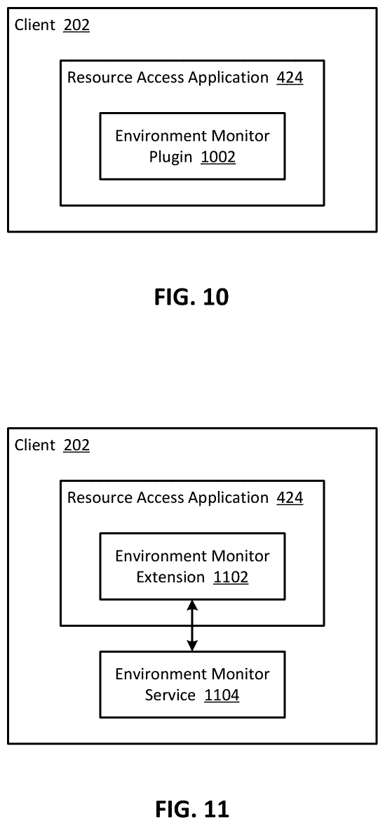

In some embodiments, and referring now to FIG. 11, resource access application 424 may be implemented as a Chromium-based application, such as a Chromium browser. In such an implementation, as can be seen in FIG. 11, resource access application 424 on client 202 may include an environment monitor extension 1102 that is configured to maintain the security tags for the notifications of resource access application 424. Environment monitor extension 1102 may also be configured to perform or not perform the sensitive information protection action on client 202 based on the security state of the environment as variously described herein.

However, since it is implemented as a Chromium-based application, resource access application 424 and, more specifically, environment monitor extension 1102, is prevented from directly accessing the underlying operating system. As a result, environment monitor extension 1102 is not able to determine a security state of the environment by utilizing a library or API of the underlying operating system. To this end, as shown in FIG. 11, client 202 includes an environment monitor service 1104 that is configured to determine a security state of the environment of client 202. For example, environment monitor service 1104 may be implemented as a native application on client 202, which allows environment monitor service 1104 to access the underlying operating system. Environment monitor service 1104 may provide a communication mechanism (e.g., inter-process communication) through which environment monitor extension 1102 can communicate with environment monitor service 1104 to determine a security state of the environment of client 202.

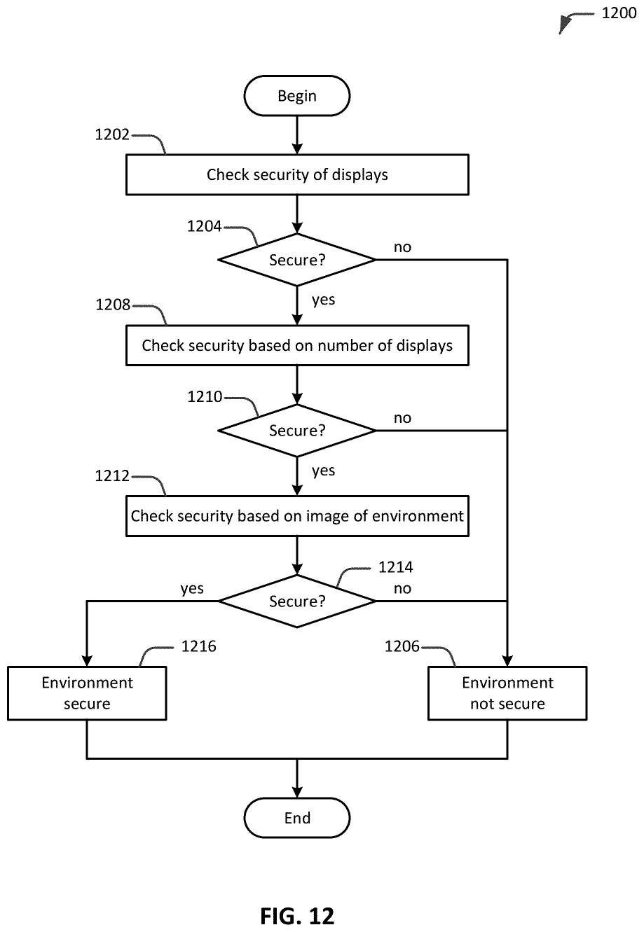

FIG. 12 is a flow diagram of an example process 1200 for determining a security state of an environment, in accordance with an embodiment of the present disclosure. Example process 1200, and example processes 1300, 1400, and 1500 further described below, may be implemented or used within a computing environment or system such as those disclosed above at least with respect to FIG. 2, FIG. 3, and/or FIGS. 4A-4C. For example, in some embodiments, the operations, functions, or actions illustrated in example process 1200, and example processes 1300, 1400, and 1500 further described below, may be stored as computer-executable instructions in a computer-readable medium, such as volatile memory 122 and/or non-volatile memory 128 of computing device 100 of FIG. 2 (e.g., computer-readable medium of client machines 102 of FIG. 1, client machines 102a-102n of FIG. 3 and/or clients 202 of FIGS. 4A-4C). In some embodiments, example process 1200, and example processes 1300, 1400, and 1500 further described below, may be implemented by application software, such as resource access application 424, which may run on a suitable computing device, such as computing device 100 of FIG. 2, client machines 102a-102n of FIG. 3, and/or clients 202 of FIGS. 4A-4C. For example, the operations, functions, or actions described in the respective blocks of example process 1200, and example processes 1300, 1400, and 1500 further described below, may be implemented by applications 116 and/or data 117 of computing device 100.

With reference to FIG. 12, process 1200 may be initiated by a client application (e.g., resource access application 424) running on a client device (e.g., client 202) to determine the security state of the environment of the client device. For example, a user (e.g., user 426) may use the client application to access a computing resource (e.g., SaaS application 410). The accessed computing resource may send or otherwise provide to the client application a page for rendering on a display of the client device. Upon receiving the page for rendering on the display of the client device, the client application can check to determine the security state of the environment. In some embodiments, while running on the client device, the client application may continually and/or periodically determine the security state of the environment (i.e., check its environment).

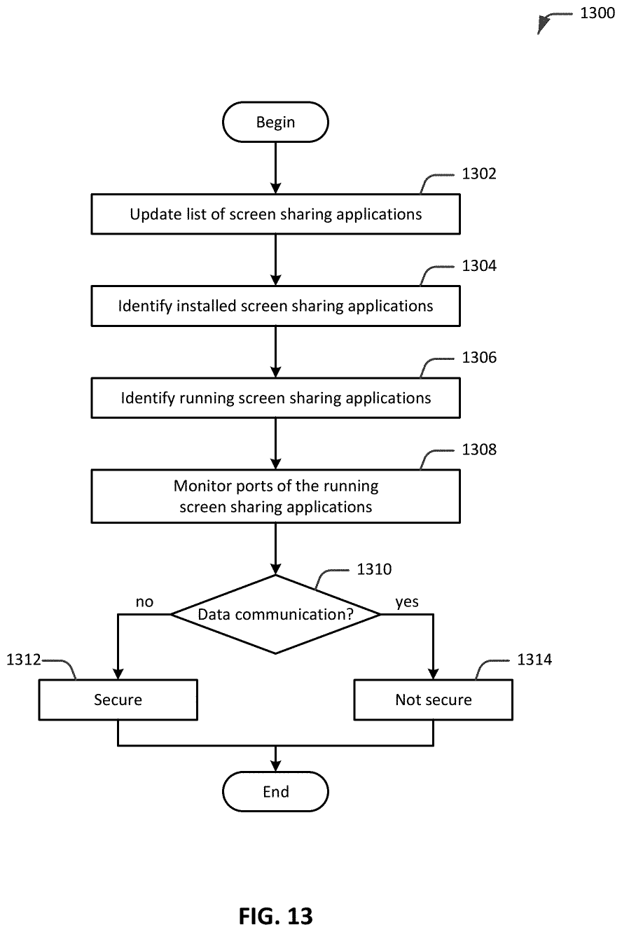

At 1202, the client application can check the security of the display or displays of the client device. Determining the security of the display or displays of the client device is further described below at least in conjunction with FIG. 13.

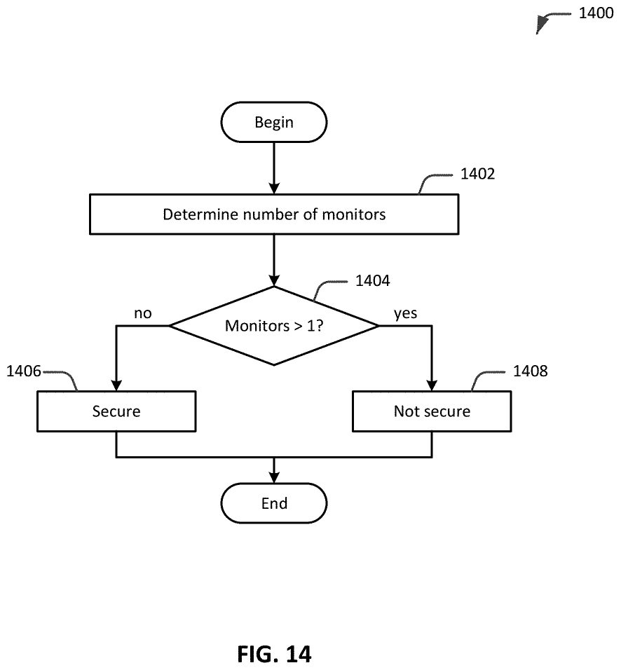

At 1204, the client application can check to determine whether the security of the display or displays of the client device is secure. If a determination is made that the display or displays is not secure, then, at 1206, the client application can conclude that the security state of the environment is not secure. Upon determining that the security state of the environment is not secure, the client application can enable sensitive information protection on the client device. Process 1200 may then end. Otherwise, if a determination is made that the display or displays is secure, then, at 1208, the client application can check the security based on the number of displays of the client device. Determining the security based on the number of displays of the client device is further described below at least in conjunction with FIG. 14.

At 1210, the client application can check to determine whether the number of displays of the client device indicate that the displays of the client device are secure. If a determination is made that the number of displays of the client device indicate that the displays are not secure, then, at 1206, the client application can conclude that the security state of the environment is not secure. Upon determining that the security state of the environment is not secure, the client application can enable sensitive information protection on the client device. Process 1200 may then end.

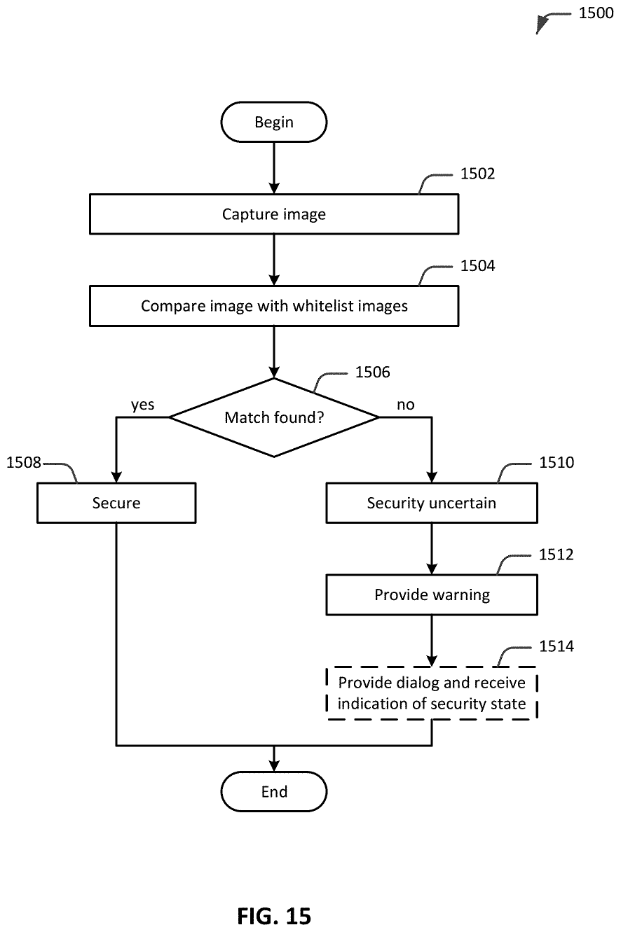

Otherwise, if a determination is made that the number of displays of the client device indicate that the displays are secure, then, at 1212, the client application can check the security based on an image of the environment. Determining the security based on an image of the environment is further described below at least in conjunction with FIG. 15.

At 1214, the client application can check to determine whether the image of the environment indicate that the environment is secure. If a determination is made that the image of the environment indicates that the environment is not secure, then, at 1206, the client application can conclude that the security state of the environment is not secure. Upon determining that the security state of the environment is not secure, the client application can enable sensitive information protection on the client device. Process 1200 may then end.

Otherwise, if a determination is made that the image of the environment indicates that the environment is secure, then, at 1216, the client application can conclude that the security state of the environment is secure. Since the environment is determined to be secure, the client application need not enable sensitive information protection on the client device. Process 1200 may then end.

FIG. 13 is a flow diagram of an example process 1300 for determining security of displays of a client device, in accordance with an embodiment of the present disclosure. Process 1300 may be initiated and, at 1302, the client application can update a list of screen sharing applications. In an implementation, applications having the ability to screen share, such as GoToMeeting™, Zoom, WeChat®, SLACK®, and Skype®, to name a few examples, may be maintained in a configuration file on or accessible by the client device. For example, a user, such as a system administrator or other authorized user, may specify the names of such screen sharing applications in a configuration file. Additionally or alternatively, the client device may retrieve the names of such screen sharing applications from a directory service. In any case, the client application can update the list of screen sharing applications from the contents of the configuration file.

At 1304, the client application can identify the screen sharing applications in the list of screen sharing applications that are installed on the client device. Note that the updated list of screen sharing applications allows the client application to efficiently search for and identify the screen sharing applications that are installed on the client device. That is, the client application does not have to check the potentially large number of applications that may be installed on the client device to determine whether an installed application is a screen sharing application. Rather, the client application can just check to determine whether a screen sharing application in the list of screen sharing applications is installed on the client device.

At 1306, the client application can identify the installed screen sharing applications that are running on the client device. The identified running screen sharing applications are the applications capable of sharing the contents that are being rendered on a display of the client device.

At 1308, the client application can monitor the ports (e.g., communication endpoints or processes) of the screen sharing applications running on the client device. The client application can monitor the ports to determine whether data is being sent across or via the ports and onto a network, for example. For instance, if data is being sent across or via the ports, it may be the case that a screen sharing application that is running on the client device is sharing its screen (e.g., sharing the contents being displayed on the display or displays of the client device).

At 1310, the client application can determine whether data is being communicated across or via the ports that are being monitored. If no data is being communicated across or via the monitored ports, then, at 1312, the client application can conclude that the display or displays of the client device is secure. In this case, since data is not being communicated across or via the ports of the screen sharing application that are running on the client device, these screen sharing applications are not performing any screen sharing. Since the screen sharing applications running on the client device are not performing screen sharing, the display or displays of the computing device can be considered secure. Process 1300 may then end.

Otherwise, if data is being communicated across or via the monitored ports, then, at 1314, the client application can conclude that the display or displays of the client device is not secure. The displays of the computing device is not secure since the screen sharing applications that are running on the client device may be sending the contents displayed on a display of the client device over the network. Process 1300 may then end.

In some embodiments, a rate of data transfer across or via a port of a screen sharing application may be compared against a data transfer threshold. If the data transfer rate or amount exceeds the data transfer threshold, the client application can conclude that the screen sharing application is performing screen sharing (i.e., that the screen sharing application is sharing a screen). In an embodiment, the data transfer threshold may be set based on historical data transfer data of prior instances of the screen sharing application or the same type of screen sharing application. For example, the data transfer rates or amounts performed by past instances of the screen sharing application may be monitored, and the data transfer threshold may be set to a mean or average of the monitored data transfer rates or amounts. In some embodiments, a data transfer threshold for a screen sharing application may be specified by an authorized user, such as a system administrator. Note that data transfer thresholds may be specified for the various screen sharing applications that are installed on the client device.

FIG. 14 is a flow diagram of an example process 1400 for determining security based on number of displays of a client device, in accordance with an embodiment of the present disclosure. Process 1400 may be initiated and, at 1402, the client application can determine the number of monitors that are coupled to the client device. Here, the check is to determine whether the user is using a multi-monitor setup (i.e., the client device is coupled to multiple displays), which may present a security risk with respect to contents that are displayed on the displays of the client device.

At 1404, the client application can check to determine whether the number of displays is larger than one (i.e., checks to determine whether there are multiple displays). If there is one display coupled to the client device, then, at 1406, the client application can conclude, at least based on the number of displays of the client device, that the environment is secure. Process 1400 may then end.

Otherwise, if there are multiple displays coupled to the client device, then, at 1408, at least based on the number of displays of the client device, that the environment is not secure. Process 1400 may then end.

In some embodiments, the client application may conclude that the security state of the environment is uncertain (i.e., cannot be determined) if a determination is made that there are multiple displays. In an embodiment, upon concluding that the security state of the environment is uncertain, the client application may provide to the user a dialog requesting that the user specify whether the environment is secure or not secure.

FIG. 15 is a flow diagram of an example process 1500 for determining security based on an image of the environment, in accordance with an embodiment of the present disclosure. Process 1500 may be initiated and, at 1502, the client application can cause the client device to capture an image of the environment surrounding or about the computing device. For example, in an implementation, the client application may trigger or request a recording means of the client device, such as a camera, webcam, or other suitable image capture device, to capture an image of the environment.

At 1504, the client application can compare the captured image of the environment with whitelist images. These whitelist images may include previously taken images of persons, objects, and/or scenes that represent or indicate a secure environment.

At 1506, the client application can check to determine whether the captured image of the environment matches at least one image from the whitelist images. In some embodiments, a pixel-by-pixel comparison of the captured image of the environment and a whitelist image may be performed to determine whether the captured image matches the whitelist image. For example, in an implementation, a match can be declared if the number of pixels matched satisfies a match threshold (e.g., more than 75% of the pixels match, more than 80% of the pixels match, or some other suitable threshold percentage indicative of matching images).

In some embodiments, facial recognition may be performed to determine whether the captured image of the environment matches a whitelist image. For example, the whitelist images may include an image of a person's face or images of people's faces. The captured image of the environment may also include an image of a face, such as the face of a user using the client application. In this example, the client application may use a suitable facial recognition application to compare selected facial features from the captured image of the environment to facial features from the whitelist images to determine whether the captured image of the environment matches a whitelist image. The concept of facial recognition is well understood in the fields of image processing, object recognition, machine learning, and deep neural networks and will not be discussed in detail here. However, for purposes of this discussion, it is sufficient to understand that the facial recognition application may operate to identify facial features by extracting landmarks or features (e.g., analyze the relative position, size, and/or shape of the eyes, nose, cheekbones, and jaw) from an image of a face in the captured image and compare these features to features in the whitelist images to determine whether there is a match.

If a match is found, then, at 1508, the client application can conclude, at least based on the comparison of the captured image of the environment with the whitelist images, that the environment is secure. Process 1500 may then end.

Otherwise, if a match is not found, then, at 1510, the client application can conclude that the security state of the environment is uncertain. In other words, the client application cannot arrive at a conclusion, at least based on the comparison of the captured image of the environment with the whitelist images, that the environment is either secure or not secure. At 1512, the client application can display or otherwise provide a warning informing of the potential for data loss or leak of displayed sensitive information.

At 1514, the client application may optionally display a dialog on the display of the client device that prompts the user to specify the security state of the environment (i.e., indicate whether the environment is secure or unsecure). The client application can then conclude that the environment is either secure or not secure based on the security state indicated by the user. In an implementation, if the user indicates that the environment is secure, the client application can include the captured image of the environment in the whitelist images. Process 1500 may then end.

The following examples pertain to further embodiments, from which numerous permutations and configurations will be apparent.

Example 1 includes a method including: responsive to a determination, by a computing device, that a screen sharing application is running in an unsecure environment, identifying sensitive information included in a notification displayed within an application window being displayed by the computing device; and obfuscating the identified sensitive information; and responsive to a determination, by the computing device, that the screen sharing application is running in an uncertain environment, providing a warning regarding a potential leak of sensitive information included in the notification displayed within the application window being displayed by the computing device.

Example 2 includes the subject matter of Example 1, wherein the determination that the screen sharing application is running in an unsecure environment is based on a data communication activity of the screen sharing application.

Example 3 includes the subject matter of any of Examples 1 and 2, wherein the determination that the screen sharing application is running in an unsecure environment is based on a number of displays coupled to the computing device.

Example 4 includes the subject matter of any of Examples 1 through 3, wherein the determination that the screen sharing application is running in an unsecure environment is based on an analysis of an image captured by a recording means coupled to the computing device.

Example 5 includes the subject matter of any of Examples 1 through 4, wherein the determination that the screen sharing application is running in an unsecure environment is based on a size of a display of the computing device.

Example 6 includes the subject matter of any of Examples 1 through 5, wherein identifying sensitive information is based on keyword analysis.

Example 7 includes the subject matter of any of Examples 1 through 6, wherein identifying sensitive information is based on a type of application providing the notification.

Example 8 includes the subject matter of any of Examples 1 through 7, wherein providing a warning regarding the potential leak of sensitive information includes: providing a dialog requesting from a user an indication of a security state of the environment of the computing device.

Example 9 includes the subject matter of Example 8, further including setting the security state of the environment based on information provided via the dialog.

Example 10 includes a system including a memory and one or more processors in communication with the memory and configured to: responsive to a determination that a screen sharing application is running in an unsecure environment, identify sensitive information included in a notification displayed within an application window being displayed by the system; and obfuscate the identified sensitive information; and responsive to a determination that the screen sharing application is running in an uncertain environment, provide a warning regarding a potential leak of sensitive information included in the notification displayed within the application window being displayed by the system.

Example 11 includes the subject matter of Example 10, wherein the determination that the screen sharing application is running in an unsecure environment is based on a data communication activity of the screen sharing application.

Example 12 includes the subject matter of any of Examples 10 and 11, wherein the determination that the screen sharing application is running in an unsecure environment is based on a number of displays coupled to the system.

Example 13 includes the subject matter of any of Examples 10 through 12, wherein the determination that the screen sharing application is running in an unsecure environment is based on an analysis of an image of the environment captured by a recording means.

Example 14 includes the subject matter of any of Examples 10 through 13, wherein the determination that the screen sharing application is running in an unsecure environment is based on a size of a display of the computing device.

Example 15 includes the subject matter of any of Examples 10 through 14, wherein to identify sensitive information is based on keyword analysis.

Example 16 includes the subject matter of any of Examples 10 through 15, wherein to identify sensitive information is based on a type of application providing the notification.

Example 17 includes the subject matter of any of Examples 10 through 16, wherein to provide a warning regarding the potential leak of sensitive information includes: provide a dialog requesting an indication of a security state of the environment in which the screen sharing application is running.

Example 18 includes the subject matter of Example 17, wherein the one or more processors are further configured to set the security state of the environment based on information provided via the dialog.

Example 19 includes a method including: determining that an application having screen share capability is running on a computing device; determining a security state of an environment of the computing device; and, responsive to a determination that the security state is unsecure, obfuscating sensitive information included in a notification displayed within an application window being displayed by the computing device.

Example 20 includes the subject matter of Example 19, wherein the security state of the environment is based on one or more of a security of one or more displays of the computing device, a number of displays coupled to the computing device, and an image of an environment of the computing device.

Example 21 includes the subject matter of any of Examples 19 and 20, further including, responsive to a determination that the security state is uncertain, providing a warning regarding a potential leak of sensitive information included in the notification displayed within the application window being displayed by the computing device.

Example 22 includes the subject matter of Example 21, wherein providing a warning regarding the potential leak of sensitive information includes: providing a dialog requesting an indication of a security state of the environment of the computing device; and setting the security state of the environment based on the indication provided via the dialog.

Example 23 includes a system including a memory and one or more processors in communication with the memory and configured to: determine that an application having screen share capability is running on a computing device; determine a security state of an environment of the computing device; and, responsive to a determination that the security state is unsecure, obfuscate sensitive information included in a notification displayed within an application window being displayed by the computing device.

Example 24 includes the subject matter of Example 23, wherein the security state of the environment is based on one or more of a security of one or more displays of the computing device, a number of displays coupled to the computing device, and an image of an environment of the computing device.

Example 25 includes the subject matter of any of Examples 23 and 24, wherein the one or more processors are further configured to: responsive to a determination that the security state is uncertain, provide a warning regarding a potential leak of sensitive information included in the notification displayed within the application window being displayed by the computing device.

Example 26 includes the subject matter of Example 25, wherein to provide a warning regarding the potential leak of sensitive information includes: to provide a dialog requesting an indication of a security state of the environment of the computing device; and to set the security state of the environment based on the indication provided via the dialog.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
responsive to a determination, by a computing device, that a screen sharing application is running in an unsecure environment,
identifying sensitive information included in a notification displayed within an application window being displayed by the computing device; and
obfuscating the identified sensitive information; and
responsive to a determination, by the computing device, that the screen sharing application is running in an uncertain environment, providing a warning regarding a potential leak of sensitive information included in the notification displayed within the application window being displayed by the computing device.

2. The method of claim 1, wherein the determination that the screen sharing application is running in an unsecure environment is based on a data communication activity of the screen sharing application.

3. The method of claim 1, wherein the determination that the screen sharing application is running in an unsecure environment is based on a number of displays coupled to the computing device.

4. The method of claim 1, wherein the determination that the screen sharing application is running in an unsecure environment is based on an analysis of an image captured by a recording means coupled to the computing device.

5. The method of claim 1, wherein identifying sensitive information is based on keyword analysis.

6. The method of claim 1, wherein identifying sensitive information is based on a type of application providing the notification.

7. The method of claim 1, wherein providing a warning regarding the potential leak of sensitive information comprises:
providing a dialog requesting from a user an indication of a security state of the environment of the computing device.

8. The method of claim 7, further comprising setting the security state of the environment based on information provided via the dialog.

9. A system comprising:
a memory; and
one or more processors in communication with the memory and configured to,
responsive to a determination that a screen sharing application is running in an unsecure environment,
identify sensitive information included in a notification displayed within an application window being displayed by the system; and
obfuscate the identified sensitive information; and
responsive to a determination that the screen sharing application is running in an uncertain environment, provide a warning regarding a potential leak of sensitive information included in the notification displayed within the application window being displayed by the system.

10. The system of claim 9, wherein the determination that the screen sharing application is running in an unsecure environment is based on a data communication activity of the screen sharing application.

11. The system of claim 9, wherein the determination that the screen sharing application is running in an unsecure environment is based on a number of displays coupled to the system.

12. The system of claim 9, wherein the determination that the screen sharing application is running in an unsecure environment is based on an analysis of an image of the environment captured by a recording means.

13. The system of claim 9, wherein to identify sensitive information is based on keyword analysis.

14. The system of claim 9, wherein to identify sensitive information is based on a type of application providing the notification.

15. The system of claim 9, wherein to provide a warning regarding the potential leak of sensitive information comprises:
provide a dialog requesting an indication of a security state of the environment in which the screen sharing application is running.

16. The system of claim 15, wherein the one or more processors are further configured to set the security state of the environment based on information provided via the dialog.

17. A method comprising:
determining that an application having screen share capability is running on a computing device;
determining a security state of an environment of the computing device; and
responsive to a determination that the security state is unsecure, obfuscating sensitive information included in a notification displayed within an application window being displayed by the computing device.

18. The method of claim 17, wherein the security state of the environment is based on one or more of a security of one or more displays of the computing device, a number of displays coupled to the computing device, and an image of an environment of the computing device.

19. The method of claim 17, further comprising, responsive to a determination that the security state is uncertain, providing a warning regarding a potential leak of sensitive information included in the notification displayed within the application window being displayed by the computing device.

20. The method of claim 19, wherein providing a warning regarding the potential leak of sensitive information comprises:
providing a dialog requesting an indication of a security state of the environment of the computing device; and
setting the security state of the environment based on the indication provided via the dialog.
